(19) United States
(12) Patent Application Publication
(10) Pub. No.: US 2012/0220153 A1
(43) Pub. Date: Aug. 30, 2012

(54) CONNECTOR AND VEHICULAR WIRE HARNESS CONNECTING STRUCTURE

(75) Inventors: Toshiaki Okabe, Makinohara-shi (JP); Shingo Chiba, Makinohara-shi (JP); Tetsuro Takasaki, Makinohara-shi (JP)

(73) Assignee: YAZAKI CORPORATION, Tokyo (JP)

(21) Appl. No.: 13/504,892

(22) PCT Filed: Nov. 26, 2010
(86) PCT No.: PCT/JP2010/071622

§ 371 Date: Apr. 27, 2012

(30) Foreign Application Priority Data
Nov. 26, 2009 (JP) 2009268928

(51) Int. Cl. H01R 4/24

(52) U.S. Cl. 439/395

(57) ABSTRACT

To provide a connector which can reduce a manufacturing cost of a wire harness, and also can enhance the reliability of the wire harness.

A first wire holder H1 adapted to be mounted on a wire harness W11 includes a wire arranging portion 36 for holding a plurality of wires 24a in parallel relation to each other, mounting shaft portions 57 disposed at one side of the wire arranging portion 36 and spaced a distance from the one side of the wire arranging portion 36, and mounting engagement portions 58 disposed at the other side of the wire arranging portion 36 and spaced a distance from the other side of the wire arranging portion 36. A holder reception portion J1 provided at an electrical equipment includes holder shaft support portions 61 for rotatably supporting the respective mounting shaft portions 57, lock portions 62 for fixing the respective mounting engagement portions 58, and a terminal fixing portion 64 which has press-contacting terminals 63 which are arranged between the holder shaft support portions 61 and the lock portions 62 and serve to press-contact the wires held by the first wire holder H1.

### TECHNICAL FIELD

This invention relates to a connector and a vehicular wire harness connecting structure.

### BACKGROUND ART

FIGS. 16 and 17 schematically show the constructions of conventional vehicular wire harness connecting structures.

The vehicular wire harness connecting structure S1 shown in FIG. 16 comprises a wire harness W1 connected to in-vehicle electrical equipments 1 and 2, harness connection portions provided respectively at the electrical equipments.

In the illustrated example, the electrical equipment 1 is a map lamp mounted on a ceiling portion above a driver's seat or other portion in a vehicle. The electrical equipment 2 is a dome lamp mounted on the ceiling portion above the driver's seal or other portion in the vehicle, and comprises a design portion 2a to be fixed to the ceiling portion, and a function portion 2b detachably attached to the design portion 2a.

The wire harness W1 shown in FIG. 16 uses ordinary separate wires (sheathed wires) as wires, and comprises a branch wire bundle wa1 to be connected to the electrical equipment 1, a branch wire bundle wa2 connected to the electrical equipment 2, a terminal connector C1 to which proximal ends of the branch wire bundles wa1 and wa2 are connected, a terminal connector C2 connected to a distal end of the branch wire bundle wa1, and the function portion 2b of the electrical equipment 2 connected to a distal end of the branch wire bundle wa2.

The terminal connector C1 is a connector to be connected by a connector to an upstream trunk wire harness, an electric connection box or the like.

The terminal connector C2 is a connector to be fitted and connected to the harness connection portion (connector portion) provided at the electrical equipment 1.

The function portion 2b is the harness connection portion of the electrical equipment 2 to which the wire harness is connected, and this function portion 2b is a unit incorporating a lamp body and a switch mechanism to which the wire harness is connected.

The vehicular wire harness connecting structure S2 shown in FIG. 17 comprises a wire harness W2 to be connected to in-vehicle electrical equipments 1 and 2, and harness connection portions provided at the electrical equipments. The electrical equipments 1 and 2 are similar to those shown in FIG. 16, and explanation thereof will be omitted.

The wire harness W2 shown in FIG. 17 uses flat wires as wires, and a branch wire wa3 to be connected to the electrical equipment 1 and a branch wire wa4 to be connected to the electrical equipment 2 are branch-connected to a basic branch wire wa5 via a connection box B1. The branch wires wa3, wa4 and wa5 are flat wires, respectively.

In this wire harness W2, a terminal connector C3 is connected to a proximal end of the basic branch wire wa5, and a terminal connector C4 is connected to a distal end of the branch wire wa3, and a function portion 2b of the electrical equipment 2 is connected to a distal end of the branch wire wa4.

The terminal connector C3 is a connector to be connected by a connector to an upstream trunk wire harness, an electric connector box or the like, and corresponds to the terminal connector C1 in the wire harness connecting structure S1 of FIG. 16.

The terminal connector C4 is a connector to be fitted and connected to the harness connection portion (connector portion) provided at the electrical equipment 1, and corresponds to the terminal connector C2 in the wire harness connecting structure S1 of FIG. 16.

FIGS. 18 to 21 show a conventional connector used for connecting a wire harness to an electrical equipment in a conventional vehicular wire harness connection structure or the like.

The connector 5 shown in FIGS. 18 to 21 is a so-called wire press-contacting type connector, and is disclosed in PTL 1 mentioned below, and is used as the terminal connector C1 and the terminal connector C2 of FIG. 16.

This connector 5 comprises a housing 7 made of an electrically-insulating material, a plurality of contacts 8 made of an electrically-conductive material and held by the housing 7, a press-contacting cover 9 made of an electrically-insulating material and connected to the housing 7, and wires 13 fitted in and press-contactingly connected to press-contacting grooves 11a formed respectively in terminal portions 11 of the contacts 8. When connecting the press-contacting cover 9 to the housing 7, the wires 13 are pressed by the press-contacting cover 9, and are press-contactingly fitted into the press-contacting grooves 11a of the contacts 8.

As shown in FIG. 21, cover-side wire holding grooves 15 are formed in the press-contacting cover 9 of the connector 5. The wires 13 to be press-contactingly fitted into the press-contacting grooves 11a are beforehand press-fitted into the cover-side wire holding grooves 15 before the press-contacting cover 9 is connected to the housing 7.

Further, housing-side wire holding grooves 16 are formed in the housing 7. At the time when the press-contacting cover 9 is connected to the housing 7, and the wires 13 are press-contactingly fitted into the press-contacting grooves 11a, the wires 13 held in the cover-side wire holding grooves 15 are pressed by the press-contacting cover 9, and are press-fitted into the housing-side wire holding grooves 16.

Another known wire press-contacting type wire harness-connecting structure is disclosed in PTL 2 mentioned below.

### CITATION LIST

### Patent Literature

[PTL 1] JP-A-2005-332796

[PTL 2] JP-A-61-161677

### SUMMARY OF INVENTION

### Technical Problem

However, in the wire harness connecting structures S1 and S2 shown respectively in FIGS. 16 and 17, an end processing operation which requires much time and labor is needed for the press-contacting connection of the wire harness to the terminal connectors C1, C2, C3 and C4, the connection of the wire harness to the function portion 2b of the electrical equipment 2, etc., in the process of the manufacture of the wire harness, and therefore there has been encountered a problem that the manufacturing cost of the wire harness becomes high.

In addition, a possibility that the terminals provided within the terminal connectors C1, C2, C3 and C4 and the function portion 2b may be stained at the time of installing the wire harness is not zero, and it has been feared that the reliability may be lowered by the degraded quality due to the staining of the terminals, etc.

Furthermore, in the above wire harness connecting structures S1 and S2, the wire harness is branch-connected to the electrical equipments, and therefore there has also been encountered a problem that the diameter and weight of the wire harness increase.

Furthermore, in the conventional wire press-contacting type connector 5 shown in FIGS. 18 to 21, the press-contacting cover 9 holding the plurality of wires 13 is pressed directly against the housing 7, and by doing so, these wires are press-fitted into the press-contacting grooves 11a of the contacts 8 provided at the housing 7. Therefore, in the case where the number of the wires 13 to be press-contactingly connected is large, a large operating force is required, and the press-contacting operation can not be carried out unless a special-purpose press-contacting jig is used. Therefore, there has been encountered a problem that the manufacture of the wire harness is difficult at a job site, etc., where such special-purpose press-contacting jig is not prepared.

It is therefore an object of this invention to solve the above problems, and more specifically to provide a connector and a vehicular wire harness connecting structure, in which a press-contacting jig specially designed for the manufacture of a wire harness, as well as an end processing operation requiring much time and labor, is not necessary, so that the manufacturing cost of the wire harness can be reduced, and also the quality is not degraded by the staining of terminals, etc., at the time of installing the wire harness, so that the reliability can be enhanced.

### Solution to Problem

The above object of the present invention has been achieved by the following constructions.

(1) A connector comprising:

a wire holder adapted to be mounted on a wire harness and having a wire arranging portion that holds a plurality of wires configuring the wire harness in parallel relation to each other, and a holder reception portion provided at an electrical equipment and serving as a harness connection portion to which the wire harness is to be connected;

wherein the wire holder includes a mounting shaft portion disposed at one side of the wire arranging portion and spaced a distance from the one side of the wire arranging portion, and a mounting engagement portion disposed at the other side of the wire arranging portion and spaced a distance from the other side of the wire; and

the holder reception portion includes a holder shaft support portion that rotatably supports the mounting shaft portion, a lock portion that engages with the mounting engagement portion of the wire holder that pivotally moves using the holder shaft support portion as a rotation fulcrum so as to fix the wire holder, and a terminal fixing portion that has a plurality of press-contacting terminals that are arranged between the holder shaft support portion and the lock portion in accordance with an arrangement of the wires at the wire arranging portion so that when the wire holder is fixed to the lock portion, press-contacting connection of the press-contacting terminals to the wires disposed at the wire arranging portion is completed.

(2) The connector according to (1), wherein the wire holder comprises an inner frame body that is located close to the terminal fixing portion when the wire holder is fixed to the holder reception portion, and an outer frame body that is superposed on an upper surface of the inner frame body to hold the plurality of wires between it and the inner frame body; and the mounting shaft portion and the mounting engagement portion are formed integrally on the outer frame body.

(3) The connector according to (1) or (2), wherein the outer frame body of the wire holder has an outer edge portion extending to be disposed outwardly of the mounting shaft portion relative to the wire arranging portion; and

the holder shaft support portion includes a notched groove into which an end portion of the mounting shaft portion is inserted in a direction perpendicular to an axis of the mounting shaft portion when the wire holder is disposed in a vertically-upstanding condition relative to the holder reception portion, and a withdrawal prevention portion constructed such that when the wire holder is pivotally moved toward the terminal fixing portion after the mounting shaft portion reaches an inner end of the notched groove, the withdrawal prevention portion abuts against the outer edge portion moving outside the notched groove by this pivotal movement, thereby restraining withdrawal of the mounting shaft portion.

(4) The connector according to any one of (1) to (3), wherein the press-contacting terminals arranged at the terminal fixing portion have respective press-contacting grooves into which the wires are inserted, respectively, and the press-contacting grooves are formed into an arc-shape, and are disposed respectively on and along loci of movement of the wires during the pivotal movement of the wire holder.

(5) A vehicular wire harness connecting structure in which the wire holder as defined in any one of (1) to (3) is mounted on a connection portion of a wire harness to be connected to an in-vehicle electrical equipment, and the holder reception portion as defined in any one of (1), (3) and (4) is provided at the electrical equipment, and the wire holder is fixed to the holder reception portion of the electrical equipment so as to connect the electrical equipment and the wire harness.

In the construction of the above (1), the mounting shaft portion disposed at the one side of the wire arranging portion of the wire holder mounted on the wire harness is brought into engagement with the holder shaft support portion of the holder reception portion provided at the electrical equipment, and the wire holder is pivotally moved, using the holder shaft support portion as the rotation fulcrum, and is laid down on the terminal fixing portion, and the mounting engagement portion disposed at the other side of the wire arranging portion is brought into engagement with the lock portion, and by doing so, the wire holder is fixed to the holder reception portion.

When the wire holder is thus fixed to the holder reception portion, the plurality of wires held at the wire arranging portion of the wire holder are press-contactingly connected respectively to the plurality of press-contacting terminals arranged at the terminal fixing portion of the holder reception portion, so that the electrical connection between the wire harness and the electrical equipment is completed.

And besides, the pivotal movement of the wire holder, in which the wire holder is pivotally moved using the holder shaft support portion of the holder reception portion as the rotation fulcrum so as to fix the wire holder to the lock portion, is effected by pressing that portion of the wire holder which is as far as possible from the rotation fulcrum for the wire holder, and by doing so, the wire holder functions as a lever. Therefore, even if the operating force is small, the plurality of wires can be positively pressed respectively into the plurality of press-contacting terminals, and the press-contacting connection can be completed. Therefore, in the connector having the construction of the above Paragraph (1), any special-purpose jig is not required for the press-contacting connection of the wires, and the press-contacting connection can be easily completed with the small operating force. Furthermore, the press-contacting starts sequentially from that side near to the fulcrum, and therefore the peaks of the press-contacting are staggered, so that the insertion force can be reduced.

Furthermore, in the manufacture of the wire harness to be connected to the electrical equipment via the connector having the construction of the above Paragraph (1), the part which need to be mounted on that portion of the wire harness to be connected to the electrical equipment is only the wire holder regardless of the kind of the electrical equipment to which the wire harness is to be connected. And besides, the wire holder merely holds the plurality of wires (forming the wire harness) in parallel relation, and will not effect the press-contacting connection of the wires, and therefore the wire holder can be easily mounted on the wire harness with a small force. Therefore, the manufacturing cost of the wire harness can be reduced.

Furthermore, the wire holder to be mounted on the wire harness does not hold the press-contacting terminals and has the simple construction, and therefore the quality will not be degraded by the staining of the terminals, etc., at the time of installing the wire harness, so that the reliability can be enhanced.

In the construction of the above (2), when the wire holder mounted on the wire harness is pivotally moved using the holder shaft support portion as the rotation fulcrum, and is laid down on the terminal fixing portion, the outer frame body presses the wires against the respective press-contacting terminals, and therefore the wires can be positively pressed into the respective press-contacting terminals, and the reliability of the press-contacting connection can be enhanced.

In the construction of the above (3), the operation for engaging the mounting shaft portion of the wire holder with the holder shaft support portion of the holder reception portion can be effected merely by inserting the mounting shaft portion into the notched groove of the holder shaft support portion, with the wire holder kept in the vertically-upstanding posture, and the operation for pivotally connecting the wire holder to the holder reception portion becomes easy, and the handling ability of the connector can be enhanced.

In the construction of the above (4), at the time when each wire held at the wire holder is pressed into the press-contacting groove of the press-contacting terminal provided at the terminal fixing portion by pivotally moving the wire holder, the direction of extending of the press-contacting groove coincides with the direction of insertion of the wire since the press-contacting groove is formed into the arc-shape and is disposed on and along the locus of movement of the wire during the pivotal movement of the wire holder. Therefore, there can be avoided a situation in which the wire is pressed into the press-contacting groove while being offset to one side of this press-contacting groove, so that an offset load acts on the wire. Therefore, the wire cutting, etc., due to the offset load can be prevented, and the press-contacting connection of a high reliability can be achieved.

In the construction of the above (5), the part which need to be mounted on that portion of the wire harness to be connected to the electrical equipment is only the wire holder regardless of the kind of the electrical equipment to which the wire harness is to be connected. And besides, the wire holder merely holds the plurality of wires (forming the wire harness) in parallel relation, and will not effect the press-contacting connection of the wires, and therefore the wire holder can be easily mounted on the wire harness with a small force. Therefore, the manufacturing cost of the wire harness can be reduced.

Furthermore, the wire holder to be mounted on the wire harness does not hold the press-contacting terminals and has the simple construction, and therefore the quality will not be degraded by the staining of the terminals, etc., at the time of installing the wire harness, so that the reliability can be enhanced.

Furthermore, the wire holder corresponds to a press-contacting cover of a conventional wire press-contacting type connector, and as compared with the case of connecting the conventional wire press-contacting type connector to a wire harness, the wire harness can be formed into a small and lightweight design.

Furthermore, the wire holder provided at an intermediate portion of the wire harness is constructed such that the wires are passed through the wire holder, and the electrical connection of this wire holder to the corresponding holder reception portion is made by a through connection, and by doing so, the wire harness can be formed into the simple structure having no branch structure.

### Advantageous Effects of Invention

In the connector of the present invention, the pivotal movement of the wire holder, in which the wire holder is pivotally moved using the holder shaft support portion of the holder reception portion as the rotation fulcrum so as to fix the wire holder to the lock portion, is effected by pressing that portion of the wire holder disposed near to the mounting engagement portion, and by doing so, the wire holder functions as a lever. Therefore, even if the operating force is small, the plurality of wires can be positively pressed respectively into the plurality of press-contacting terminals, and the press-contacting connection can be completed. Therefore, in the connector of the invention, any special-purpose jig is not required for the press-contacting connection of the wires, and the press-contacting connection can be easily completed with the small operating force. Furthermore, the press-contacting starts sequentially from that side near to the fulcrum, and therefore the peaks of the press-contacting are staggered, so that the insertion force can be reduced.

In the vehicular wire harness connecting structure of the present invention, the part which need to be mounted on that portion of the wire harness to be connected to the electrical equipment is only the wire holder regardless of the kind of the electrical equipment to which the wire harness is to be connected. And besides, the wire holder merely holds the plurality of wires (forming the wire harness) in parallel relation, and will not effect the press-contacting connection of the wires, and therefore the wire holder can be easily mounted on the wire harness with a small force. Therefore, the manufacturing cost of the wire harness can be reduced.

Furthermore, the wire holder to be mounted on the wire harness does not hold the press-contacting terminals and has the simple construction, and therefore the quality will not be degraded by the staining of the terminals, etc., at the time of installing the wire harness, so that the reliability can be enhanced.

Furthermore, the wire holder corresponds to the press-contacting cover of the conventional wire press-contacting type connector, and as compared with the case of connecting the conventional wire press-contacting type connector to a wire harness, the wire harness can be formed into a small and lightweight design.

Furthermore, the wire holder can be provided at an intermediate portion of the wire harness, and this wire holder provided at the intermediate portion of the wire harness is electrically connected to the corresponding holder reception portion by a through connection, and by doing so, the wire harness can be formed into the simple structure having no branch structure.

### BRIEF DESCRIPTION OF DRAWINGS

FIG. 1 is a view schematically showing a first embodiment of a vehicular wire harness connecting structure of the present invention.

FIG. 2 is a plan view showing a condition in which an inner frame body and an outer frame body of a wire holder to be mounted on a distal end of a wire harness of FIG. 1 are opened.

FIG. 3 is a perspective view of the wire holder shown in FIG. 2.

FIG. 4 is a plan view showing a condition in which the inner frame body and the outer frame body of the wire holder mounted on the distal end of the wire harness of FIG. 1 are closed.

FIG. 5 is a perspective view of the wire holder shown in FIG. 4.

FIG. 6 is a perspective view of an electrical equipment (lamp) having a holder reception portion to which the wire holder of FIG. 5 is attached.

FIG. 7 is an enlarged view of a portion A (holder reception portion) of FIG. 6.

FIG. 8 is a perspective view showing a condition in which the wire holder of FIG. 5 is vertically inserted into the holder reception portion of FIG. 6, and mounting shaft portions of the wire holder are engaged respectively with holder shaft support portions of the holder reception portion.

FIG. 9 is an enlarged view of the holder reception portion shown in FIG. 8.

FIG. 10 is a perspective view showing a condition in which the wire holder of FIG. 5 is fixed to the holder reception portion of FIG. 6.

FIG. 11 is an enlarged view of the holder reception portion shown in FIG. 10.

FIGS. 12A to 12E are views explanatory of the procedure of fixing the wire holder of FIG. 5 to the holder reception portion of FIG. 6.

FIG. 13 is a view explanatory of improved press-contacting grooves of press-contacting terminals provided at a holder reception portion of the invention.

FIG. 14A is an enlarged view showing the arc-shaped press-contacting grooves shown in FIG. 13, and FIG. 14B is a view explanatory of an operation in the case where a press-contacting groove is straight.

FIG. 15 is a view schematically showing the construction of a second embodiment of a vehicular wire harness connecting structure of the invention.

FIG. 16 is a view schematically showing the construction of a conventional vehicular wire harness connecting structure employing separate wires.

FIG. 17 is a view schematically showing the construction of a conventional vehicular wire harness connecting structure employing flat wires.

FIG. 18 is a partly cross-sectional, enlarged perspective view showing a wire press-contacting type connector used in the conventional vehicular wire harness connecting structure.

FIG. 19 is an exploded perspective view of the connector of FIG. 18.

FIG. 20 is a perspective view of the connector of FIG. 18, showing its appearance.

FIG. 21 is an enlarged perspective view showing a cover-side wire holding grooves in a press-contacting cover shown in FIG. 19.

### DESCRIPTION OF EMBODIMENTS

A connector and a vehicular wire harness connecting structure according to a preferred embodiment of the present invention will now be described in detail with reference to the drawings.

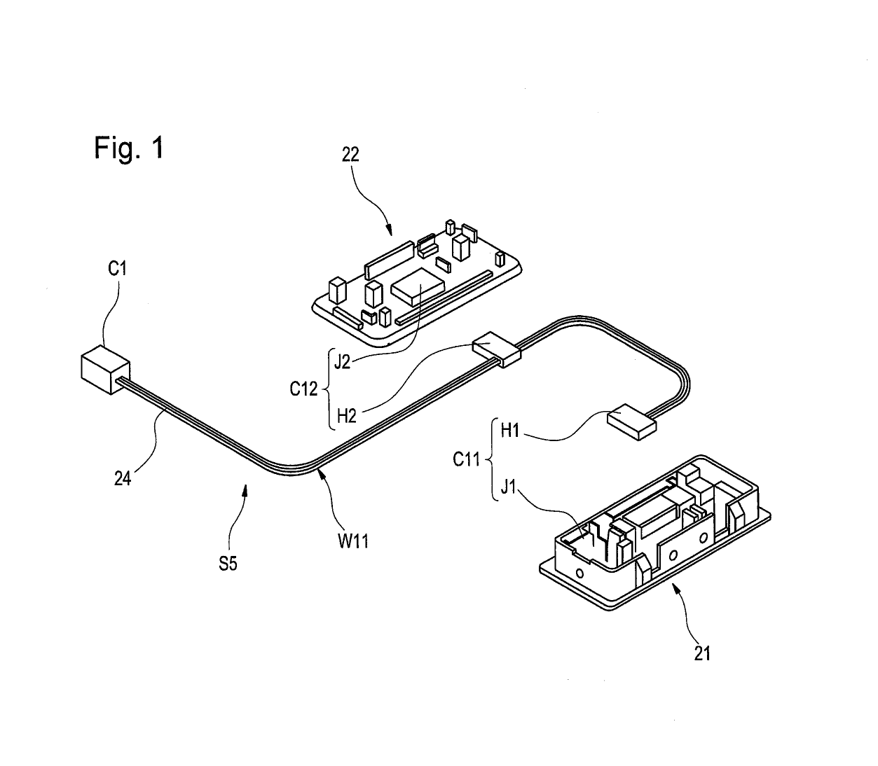

FIG. 1 is a view schematically showing the construction of a first embodiment of a vehicular wire harness connecting structure of the invention.

The vehicular wire harness connecting structure S5 of this first embodiment comprises a wire harness W11 to be connected to in-vehicle electrical equipments 21 and 22, and holder reception portion J1 and J2 provided as harness connection portions respectively at the electrical equipments.

In FIG. 1, the electrical equipment 21 is a map lamp for mounting on a ceiling portion above a driver's seat or other portion in a vehicle. The electrical equipment 22 is an assembly of a dome lamp which comprises a design portion and a function portion and is adapted to be mounted on the ceiling portion above the driver's seal or other portion in the vehicle.

The wire harness W11 shown in FIG. 1 uses ordinary separate wires (sheathed wires) as wires, and includes a group (or bundle) 24 of wires having no branch structure, a terminal connector C1 connected to a proximal end of the wire group 24, a first wire holder H1 mounted on a distal end of the wire group 24, and a second wire holder H2 mounted on an intermediate portion of the wire group 24.

The terminal connector C1 is a connector to be connected by a connector to an upstream trunk wire harness, an electric connection box or the like.

The first wire holder H1 is mounted on a connection portion of the wire harness to be connected to the electrical equipment 21, and cooperates with the holder reception portion J1 to form a connector C11 of the invention.

The second wire holder H2 is mounted on a connection portion of the wire harness to be connected to the electrical equipment 22, and cooperates with the holder reception portion J2 to form a connector C12 of the invention.

In the above-mentioned wire harness connecting structure S5, the wire holders H1 and H2 are fixed respectively to the holder reception portions J1 and J2 of the corresponding electrical equipments 21 and 22, thereby connecting the electrical equipments 21 and 22 to the wire harness W11.

Next, the constructions of the first wire holder H1 and the holder reception portion J1 jointly forming the connector C11 of the invention will be described.

The first wire holder H1 is mounted on the connection portion (more specifically, the distal end portion of the wire group 24) of the wire harness W11 to be connected to the electrical equipment 21.

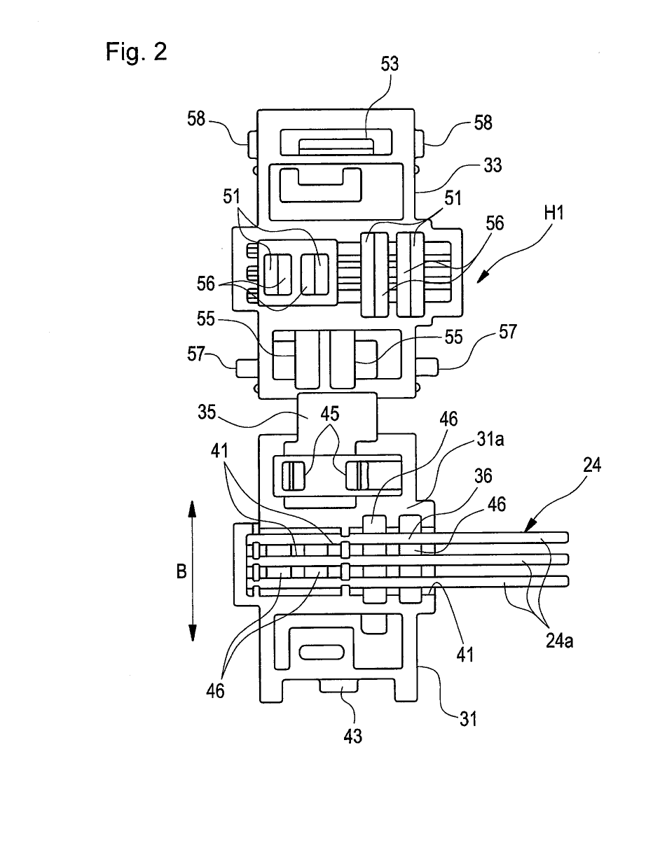

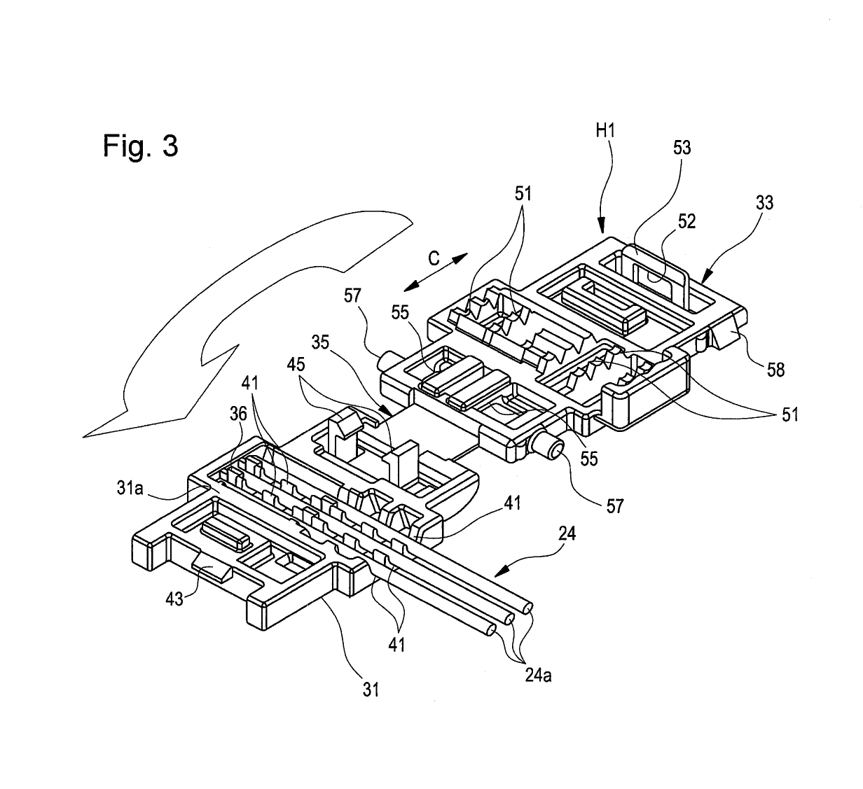

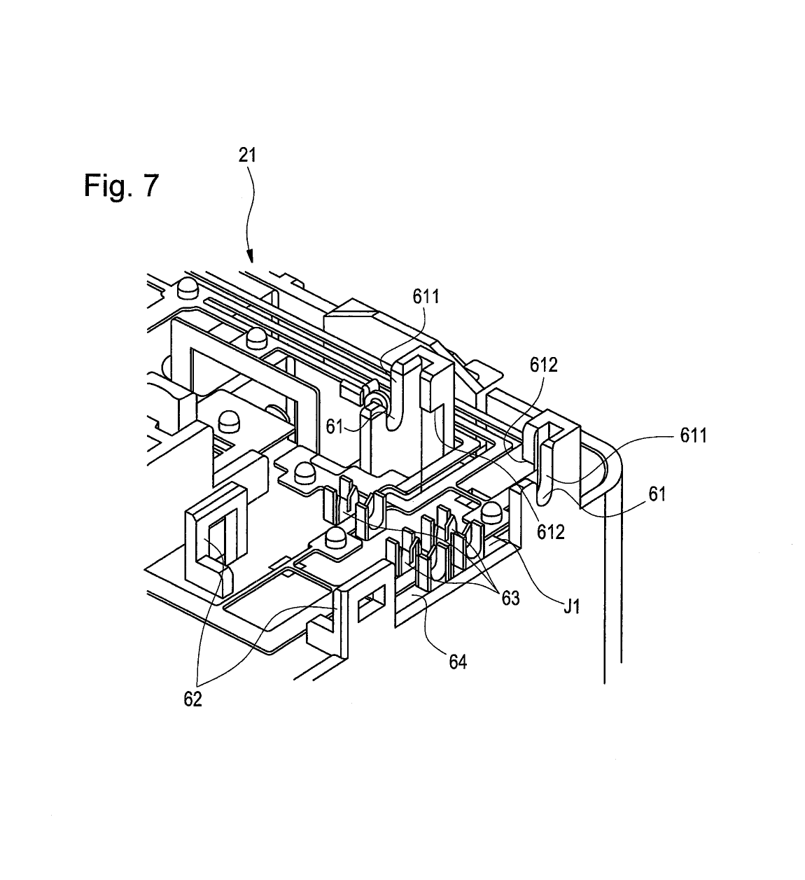

As shown in FIGS. 2 and 3, the first wire holder H1 comprises an inner frame body 31 which is located close to a terminal fixing portion 64 (described later; see FIG. 7) when the first wire holder H1 is fixed to the holder reception portion J1, an outer frame body 33 which is superposed on an upper surface 31a of the inner frame body 31 to hold the plurality of wires 24a between it and the inner frame body 31, and a thin hinge 35 pivotally interconnecting one end portions of the inner and outer frame bodies 31 and 33.

As shown in FIGS. 2 and 3, the inner frame body 31 has a plurality of wire holding grooves 41 which are formed at its intermediate portion in a direction of the length of the first wire holder H1 (that is, a direction of arrow B in FIG. 2; a direction perpendicular to a direction of extending of the wires 24a held by the wire holder H1) and fittingly hold the wires 24a, respectively. As shown in FIGS. 2 and 3, the plurality of wire holding grooves 41 hold the plurality of wires 24a in a parallel arranged condition.

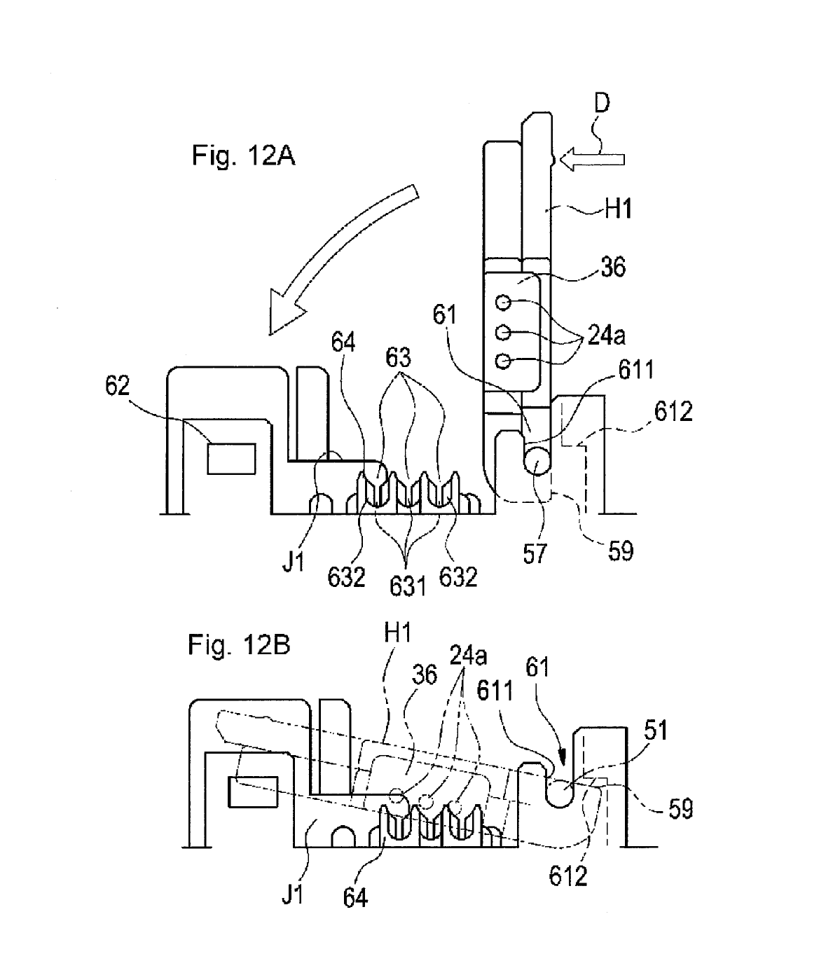

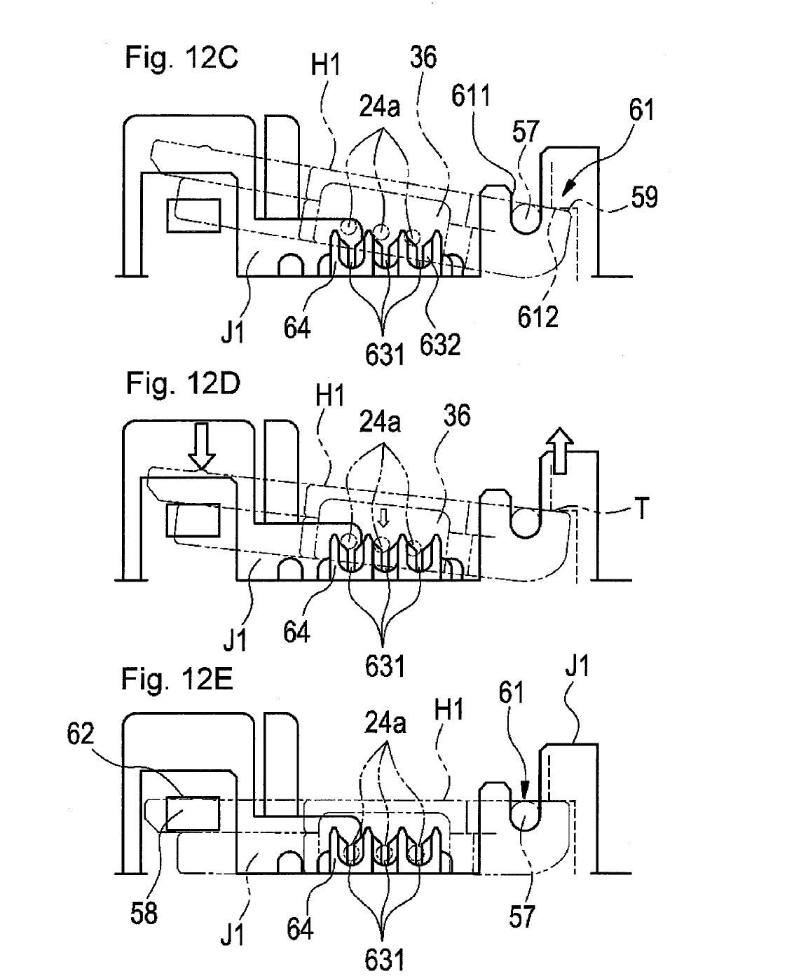

As shown in FIG. 3, the outer frame body 33 has a plurality of wire pressing portions 51 formed at its intermediate portion in the direction of the length (that is, the direction of arrow C in FIG. 3). The plurality of wire pressing portions 51 are projections which abut respectively against top portions of the wires 24a held in the respective wire holding grooves 41 when the outer frame body 33 is superposed on the upper surface 31a of the inner frame body 31. These wire pressing portions 51 press the wires 24a, held in the respective wire holding grooves 41, against bottom portions of the respective wire holding grooves 41, and also serve to press the wires 24a into press-contacting grooves 631 (see FIG. 12A) of press-contacting terminals 63 (described later) when fixing the first wire holder H1 to the holder reception portion J1 as shown in FIG. 12E.

As shown in FIG. 3, an elastic engagement piece portion 53 having an engagement hole 52 is formed at the other end portion of the outer frame body 33 remote from the thin hinge 35. A pair of frame body connecting holes 55 and 55 are formed in that portion of the outer frame body 33 disposed near to the one end of the outer frame body.

The elastic engagement piece portion 53 is spaced a predetermined distance toward the other end from the intermediate portion at which the plurality of wire pressing portions 51 are arranged. Also, the pair of frame body connecting holes 55 and 55 are spaced a predetermined distance toward the one end from the intermediate portion at which the plurality of wire pressing portions 51 are arranged.

On the other hand, a lock projection 43 corresponding to the elastic engagement piece portion 53 is formed at the other end portion of the inner frame body 31 remote from the thin hinge portion 35. A pair of elastic retaining piece portions 45 and 45 corresponding to the pair of frame connecting holes 55 and 55 are formed in a projecting manner at that portion of the inner frame body 31 disposed near to the one end thereof.

The lock projection 43 is spaced a predetermined distance toward the other end from the intermediate portion at which the plurality of wire holding grooves 41 are arranged. The pair of elastic retaining piece portions 45 and 45 are spaced a predetermined distance toward the one end from the intermediate portion at which the plurality of wire holding grooves 41 are arranged.

When the outer frame body 33 is superposed on the upper surface 31a of the inner frame body 31 as a result of bending of the thin hinge 35, the lock projection 43 is engaged in the engagement hole 52 of the elastic engagement piece portion 53, thereby locking the condition in which the outer frame body 33 is superposed on the inner frame body 31.

Also, when the outer frame body 33 is superposed on the upper surface 31a of the inner frame body 31 as a result of bending of the thin hinge 35, the pair of elastic retaining piece portions 45 and 45 are engaged respectively in the pair of frame body connecting holes 55 and 55, thereby locking the condition in which the outer frame body 33 is superposed on the inner frame body 31.

When the outer frame body 33 is superposed on the upper surface 31a of the inner frame body 31, the wire holding grooves 41 of the inner frame body 31 and the wire pressing portions 51 of the outer frame body 33 cooperate with each other to function as a wire arranging portion 36 for holding the plurality of wires in parallel relation.

Press-contacting blade passage holes 46 are formed through the inner frame body 31, and press-contacting blade passage holes 56 are formed through the outer frame body 33, and when fixing the first wire holder H1 to the holder reception portion J1, press-contacting blades of the press-contacting terminals provided at the holder reception portion J1 pass through the corresponding press-contacting blade passage holes 46 and 56.

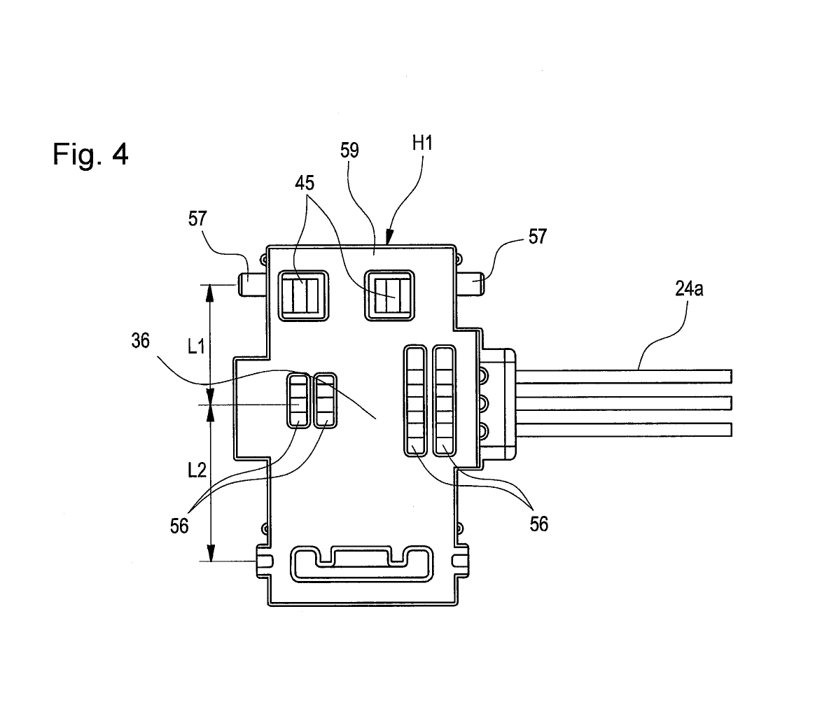

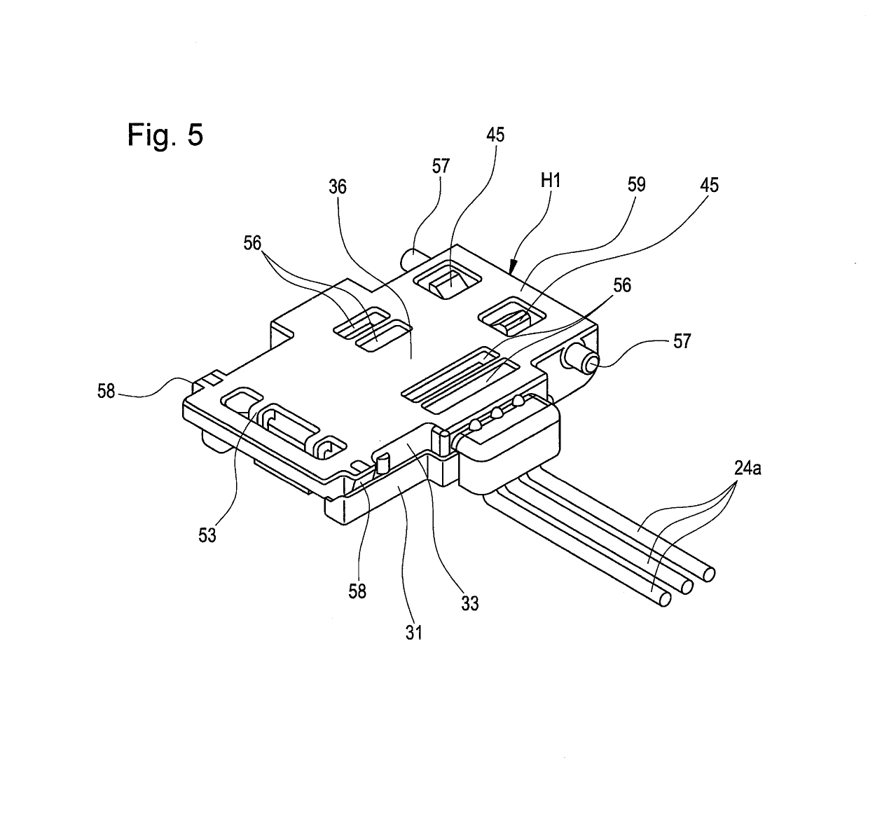

As shown in FIGS. 4 and 5, the first wire holder H1 of this embodiment includes mounting shaft portions 57 and mounting engagement portions 58 which serve as means for fixing the first wire holder H1 to the holder reception portion J1.

The mounting shaft portions 57 are disposed at one side of the wire arranging portion 36 and are spaced a suitable distance from the one side of the wire arranging portion 36 along the direction of the length of the first wire holder H1. The mounting engagement portions 58 are disposed at the other side of the wire arranging portion 36 and are spaced a suitable distance from the other side of the wire arranging portion 36 along the direction of the length of the first wire holder H1. In FIG. 4, a dimension L1 represents the distance from the centerline of the wire arranging portion 36 to the axis of the mounting shaft portion 57, and a dimension L2 represents the distance from the centerline of the wire arranging portion 36 to the axis of mounting engagement portion 58.

In this embodiment, the mounting shaft portions 57 and the mounting engagement portions 58 are formed integrally on the outer frame body 33 as shown in FIG. 3. In this embodiment, the outer frame body 33 has an outer edge portion 59 extending to be disposed outwardly of the mounting shaft portions 57 relative to the wire arranging portion 36, as shown in FIG. 4.

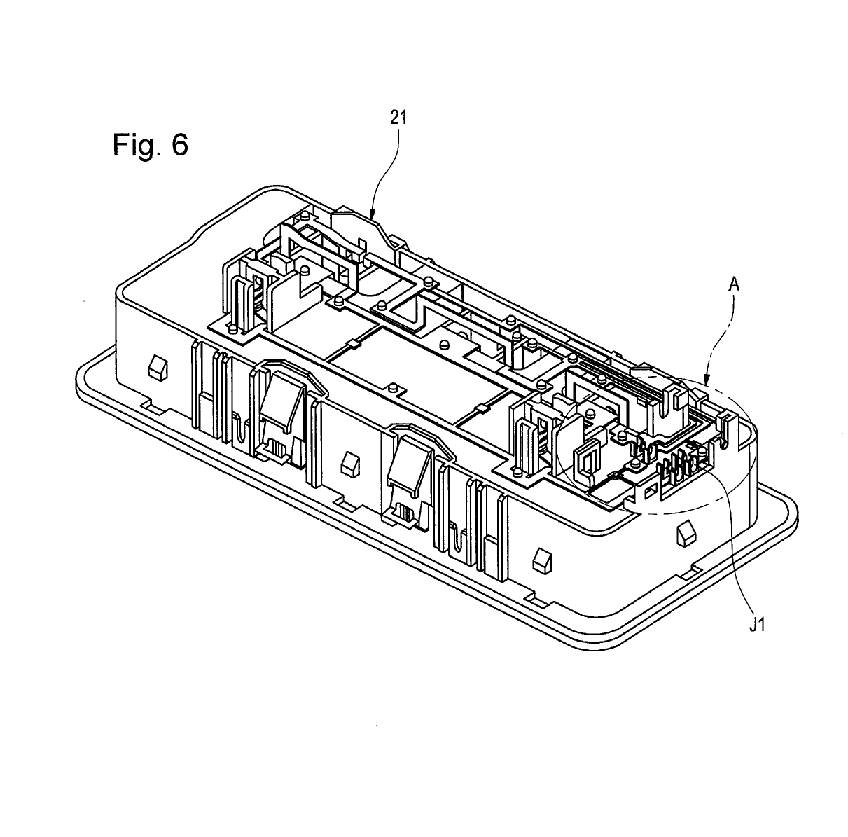

As shown in FIGS. 6 and 7, the holder reception portion J1 of this embodiment is provided in the electrical equipment 21, and serves as the harness connection portion to which the wire harness W1 is connected.

As shown in FIG. 7, the holder reception portion J1 includes holder shaft support portions 61, lock portions 62, the press-contacting terminals 63, and the terminal fixing portion 64.

The holder shaft support portions 61 are bearing portions for respectively rotatably supporting the mounting shaft portions 57 of the first wire holder H1. In this embodiment, each holder shaft support portion 61 has a notched groove 611, and a withdrawal prevention portion 612.

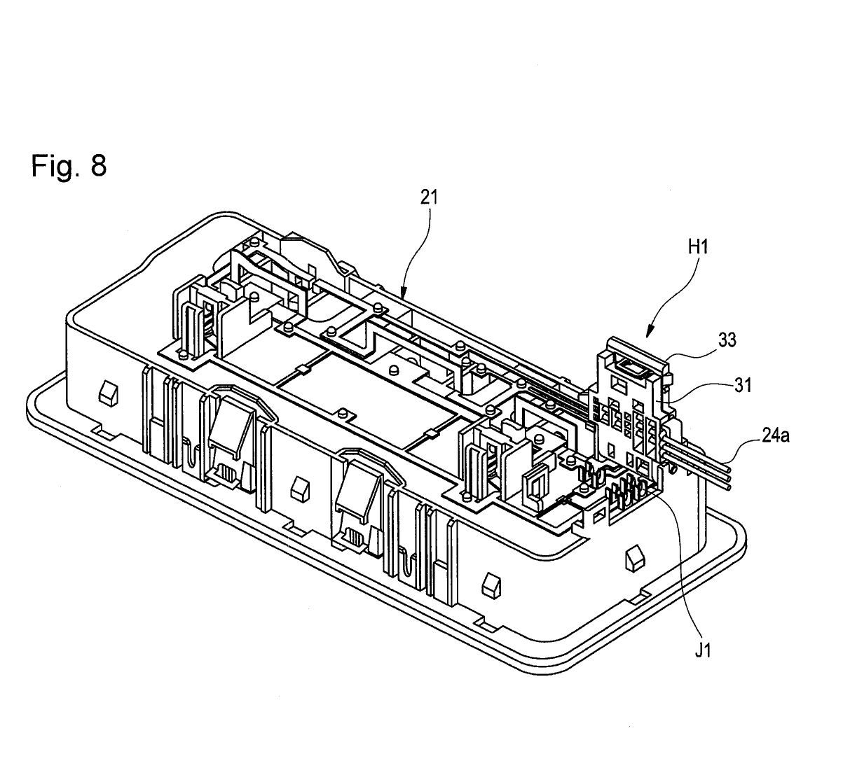

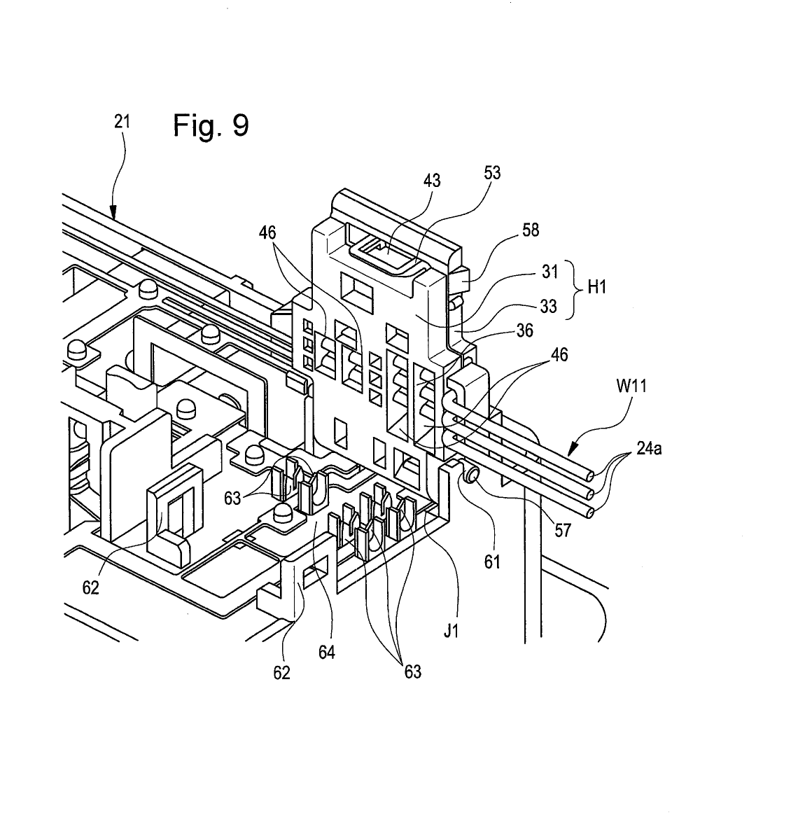

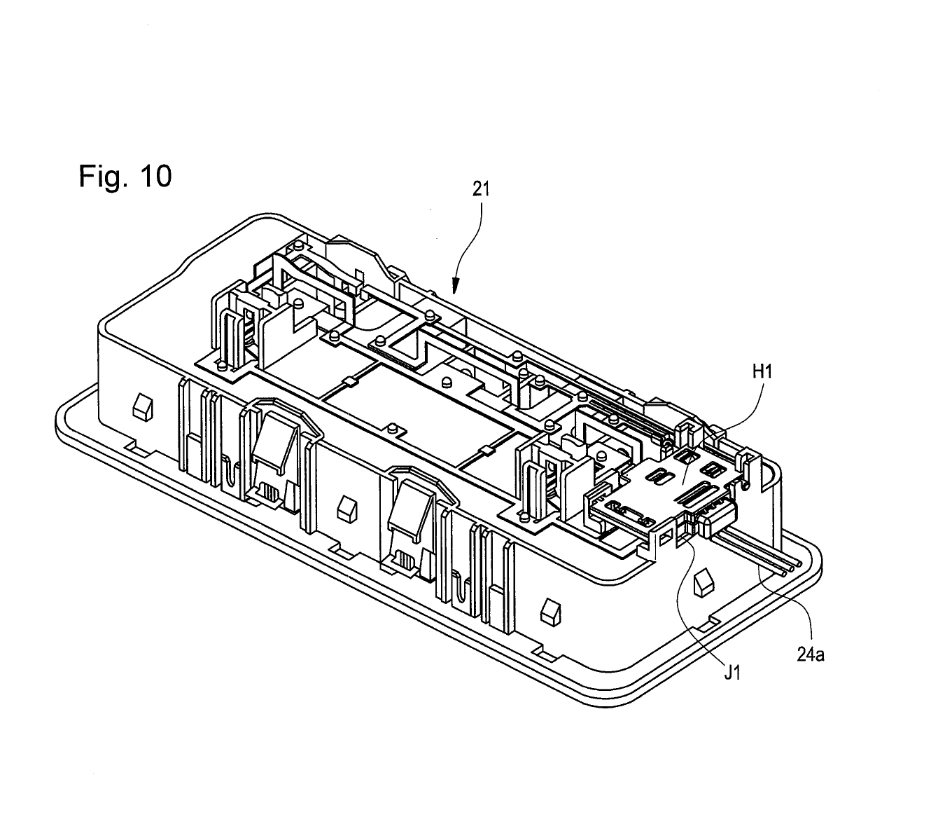

As shown in FIGS. 8 and 9, the notched grooves 611 are such grooves that when the first wire holder H1 is disposed in a vertically-upstanding condition relative to the holder reception portion J1, an end portion of each mounting shaft portion 57 can be inserted into the corresponding notched groove 611 in a direction perpendicular to the axis thereof.

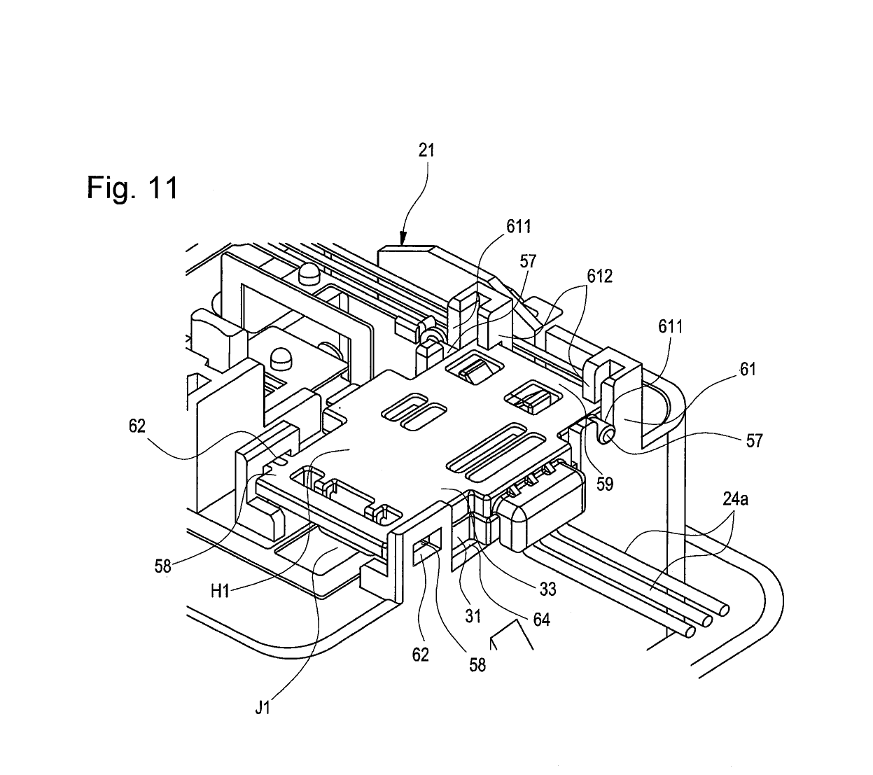

When the first wire holder H1 is pivotally moved toward the terminal fixing portion 64 after each mounting shaft portion 57 reaches an inner end of the notched groove 611 as shown in FIG. 12A, the outer edge portion 59 moving outside the notched groove 611 during this pivotal movement is brought into abutting engagement with the withdrawal prevention portion 612 as shown in FIGS. 11 and 12C, thereby restraining the mounting shaft portion 57 from being withdrawn from the notched groove 611.

The lock portions 62 are holes into which the mounting engagement portions 58 of the first wire holder H1 can be fitted, respectively. As shown in FIGS. 11 and 12E, the lock portions 62 are engaged respectively with the mounting engagement portions 58 of the first wire holder H1 pivotally moved using the holder shaft support portions 61 as a rotation fulcrum, and fixes the first wire holder H1.

As shown in FIG. 12A, each press-contacting terminal 63 is the type of terminal in which the press-contacting groove 631 into which the wire 24a is pressed is formed by the opposed press-contacting blades 632. When the wire 24a is pressed into the press-contacting groove 631, the press-contacting blades 632 cut an insulating sheath of the wire 24a, and are conductively contacted with a conductor within the wire. The press-contacting terminals 63 are electrically connected to a circuit of the electrical equipment 21. In this embodiment, each press-contacting groove 631 is formed into a straight shape and extends straight in the vertical direction.

The terminal fixing portion 63 is the portion having the plurality of press-contacting terminals 63 arranged between the holder shaft support portions 61 and the lock portions 62. As shown in FIG. 12E, the terminal fixing portion 64 fixedly supports the press-contacting terminals 63 in accordance with the arrangement of the wires at the wire arranging portion 36 so that when the first wire holder H1 is fixed to the lock portions 62 as shown in FIG. 12E, the press-contacting connection of the press-contacting terminals 63 to the wires 24a at the wire arranging portion 36 can be completed.

The first wire holder H1 described above is fixed to the holder reception portion J1 according to the procedure shown in FIGS. 12A to 12E.

Namely, first, the mounting shaft portions 57 are inserted respectively into the notched grooves 611 of the holder shaft support portions 61, with the first wire holder H1 kept in a vertically-upstanding posture as shown in FIG. 12A.

Then, the first wire holder H1 is pivotally moved, using the holder shaft support portions 61 (those portions thereof near to the inner ends of the notched grooves 611) as the rotation fulcrum, and is laid down on the terminal fixing portion 64 as shown in FIG. 12B. Incidentally, when a portion (for example, the vicinity of a portion indicated by arrow D in FIG. 12A) which is as far as possible from the rotation fulcrum is pressed so as to pivotally move the first wire holder H1, this operation can be effected with a small operating force, utilizing the principle of a lever.

When the wires 24a at the wire arranging portion 36 of the first wire holder H1 are brought into abutting engagement with open edges of the press-contacting grooves 631 of the press-contacting terminals 63, provided at the terminal fixing portion 64, as a result of pivotal movement of the first wire holder H1 as shown in FIG. 12C, the mounting shaft portions 57 are slightly lifted from the inner ends of the notched grooves 611 by a reaction force from the press-contacting blades. At the same time, the outer edge portion 59 of the first wire holder H1 is brought into abutting engagement with the withdrawal prevention portions 612 of the holder shaft support portions 61.

When the first wire holder H1 having the outer edge portion 59 held against the withdrawal prevention portions 612 is further laid down toward the terminal fixing portion 64, the first wire holder H1 is pivotally moved toward the terminal fixing portion 64, using, as a rotation fulcrum, abutting portions T where the outer edge portion 59 abut against the withdrawal prevention portions 612, as shown in FIG. 12D. At this time, the wires 24a at the wire arranging portion 36 are pressed into the press-contacting grooves 631 by the wire pressing portions 51 of the outer frame body 33.

Then, when the mounting engagement portions 58 of the first wire holder H1 are engaged respectively with the lock portions 62 of the holder reception portion J1 as shown in FIG. 12E, the first wire holder H1 is fixed to the holder reception portion J1, and at the same time the press-contacting connection of the wires 24a, provided at the wire arranging portion 36, to the press-contacting terminals 63 is completed.

In the wire harness connecting structure S5 of the first embodiment, the second wire holder H2 forming the connector C12 is identical in construction to the first wire holder H1 except that notches for the passage of the wire group 24 therethrough are formed in a peripheral wall of the first wire holder H1 so that the second wire holder can be mounted on the intermediate portion of the wire group 24, and therefore explanation thereof will be omitted. Also, the holder reception portion J2 forming the connector C12 is identical in construction to the holder reception portion J1, and therefore explanation thereof will be omitted.

As described above, in the connector C11 of the first embodiment, the mounting shaft portions 57 disposed at one side of the wire arranging portion 36 of the first wire holder H1 mounted on the wire harness W11 are brought into engagement with the respective holder shaft support portions 61 of the holder reception portion J1 provided at the electrical equipment, and the first wire holder H1 is pivotally moved, using the holder shaft support portions 61 as the rotation fulcrum, and is laid down on the terminal fixing portion 64, and the mounting engagement portions 58 at the other side of the wire arranging portion 36 are brought into engagement with the respective lock portions 62, and by doing so, the first wire holder H1 is fixed to the holder reception portion J1.

When the first wire holder H1 is thus fixed to the holder reception portion J1, the plurality of wires 24a held at the wire arranging portion 36 of the first wire holder H1 are press-contactingly connected to the plurality of press-contacting terminals 63 arranged at the terminal fixing portion 64 of the holder reception portion J1, so that the electrical connection between the wire harness W11 and the electrical equipment 21 is completed.

And besides, the pivotal movement of the first wire holder H1, in which the first wire holder H1 is pivotally moved using the holder shaft support portions 61 of the holder reception portion J1 as the rotation fulcrum so as to fix the first wire holder H1 to the lock portions 61, is effected by pressing the portion which is as far as possible from the rotation fulcrum for the first wire holder H1, and by doing so, the first wire holder H1 functions as a lever. Therefore, even if the operating force is small, the plurality of wires 24a can be positively pressed into the plurality of press-contacting terminals 63, and the press-contacting connection can be completed. Therefore, in the connector C11 of the above first embodiment, any special-purpose jig is not required for the press-contacting connection of the wires 24a, and the press-contacting connection can be completed with the small operating force.

Furthermore, in the manufacture of the wire harness W11 to be connected to the electrical equipments 21 and 22 via the connectors C11 and C12 of the first embodiment, the parts which need to be mounted respectively on those portions of the wire harness W11 to be connected respectively to the electrical equipments 21 and 22 are only the wire holders H1 and H2 of the similar construction regardless of the kind of the electrical equipments 21 and 22 to which the wire harness W11 is to be connected. And besides, the wire holders H1 and H2 merely hold the plurality of wires 24a (forming the wire harness W11) in parallel relation, and will not effect the press-contacting connection of the wires, and therefore the wire holders can be easily mounted on the wire harness W11 with a small force. Therefore, the manufacturing cost of the wire harness W11 can be reduced.

Furthermore, the wire holders H1 and H2 to be mounted on the wire harness W11 do not hold the press-contacting terminals and have the simple construction, and therefore the quality will not be degraded by the staining of the terminals, etc., at the time of installing the wire harness W11, so that the reliability can be enhanced.

Furthermore, in the above first embodiment, the first wire holder H1 includes the inner frame body 31 which is disposed near to the terminal fixing portion 64 when the first wire holder is fixed to the holder reception portion J1, and the outer frame body 33 which is superposed on the upper surface of the inner frame body 31 to hold the plurality of wires 24a between it and the inner frame body 31, as shown in FIG. 5 and FIG. 11. Further, the mounting shaft portions 57 and the mounting engagement portions 58 are formed integrally on the outer frame body 33.

Therefore, when the first wire holder H1 mounted on the wire harness W11 is pivotally moved using the holder shaft support portions 61 as the rotation fulcrum, and is laid down on the terminal fixing portion 64, the outer frame body 33 presses the wires 24a against the press-contacting terminals 63, and therefore the wires 24a can be positively pressed into the press-contacting grooves 631 of the press-contacting terminals 63, and the reliability of the press-contacting connection can be enhanced.

In the above first embodiment, the outer frame body 33 of the first wire holder H1 has the outer edge portion 59 extending to be disposed outwardly of the mounting shaft portions 57 relative to the wire arranging portion 36, as shown in FIGS. 4 and 5.

Furthermore, as shown in FIGS. 7 and 11, the holder shaft support portion 61 includes the notched groove 611 into which the end portion of the mounting shaft portion 57 can be inserted in the direction perpendicular to the axis thereof when the first wire holder H1 is disposed in the vertically-upstanding condition relative to the holder reception portion J1, and the withdrawal prevention portion 612 constructed such that when the first wire holder H1 is pivotally moved toward the terminal fixing portion 64 after the mounting shaft portion 57 reaches the inner end of the notched groove 611, the withdrawal prevention portion 612 is brought into abutting engagement with the outer edge portion 59 moving outside the notched groove 611 during this pivotal movement, thereby restraining the withdrawal of the mounting shaft portion 57.

Therefore, the operation for engaging each mounting shaft portion 57 of the first wire holder H1 with the holder shaft support portion 61 of the holder reception portion J1 can be effected merely by inserting the mounting shaft portion 57 into the notched groove 611 of the holder shaft support portion 61, with the first wire holder H1 kept in the vertically-upstanding posture as shown in FIG. 12A, and the operation for pivotally connecting the first wire holder H1 to the holder reception portion J1 becomes easy, and the handling ability of the connector can be enhanced.

Furthermore, in the wire harness connecting structure S5 of the above first embodiment, the wire holders H1 and H2 are mounted respectively on the portions of the wire harness W11 which are to be connected respectively to the in-vehicle electrical equipments 21 and 22, and the holder reception portions J1 and J2 are provided respectively in the electrical equipments 21 and 22, and the wire holders H1 and H2 are fixed respectively to the holder reception portions J1 and J2 of the electrical equipments 21 and 22, and by doing so, the electrical equipments 21 and 22 are connected to the wire harness W11.

Namely, the parts which need to be mounted respectively on those portions of the wire harness W11 to be connected respectively to the electrical equipments 21 and 22 are only the wire holders H1 and H2 of the similar construction regardless of the kind of the electrical equipments 21 and 22 to which the wire harness W11 is to be connected. And besides, the wire holders H1 and H2 merely hold the plurality of wires 24a (forming the wire harness W11) in parallel relation, and will not effect the press-contacting connection of the wires, and therefore the wire holders can be easily mounted on the wire harness W11 with a small force. Therefore, the manufacturing cost of the wire harness W11 can be reduced.

Furthermore, the wire holders H1 and H2 to be mounted on the wire harness W11 do not hold the press-contacting terminals 63 and has the simple construction, and therefore the quality will not be degraded by the staining of the terminals, etc., at the time of installing the wire harness W11, so that the reliability can be enhanced.

Furthermore, each of the wire holders H1 and H2 corresponds to a press-contacting cover of a conventional wire press-contacting type connector, and as compared with the case of connecting the conventional wire press-contacting type connector to a wire harness, the wire harness W11 can be formed into a small and lightweight design.

Furthermore, the wire holder H2 provided at the intermediate portion of the wire harness W11 is constructed such that the wires 24a are passed through the wire holder H2, and the electrical connection of this wire holder H2 to the corresponding holder reception portion J2 is made by a through connection, and by doing so, the wire harness W11 can be formed into the simple structure having no branch structure.

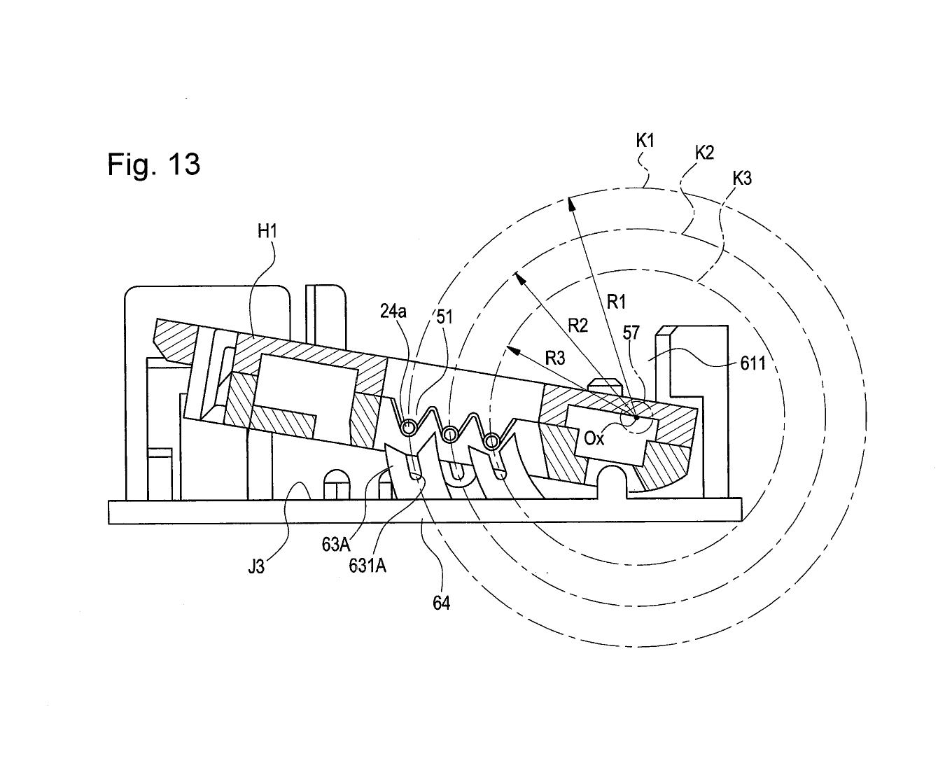

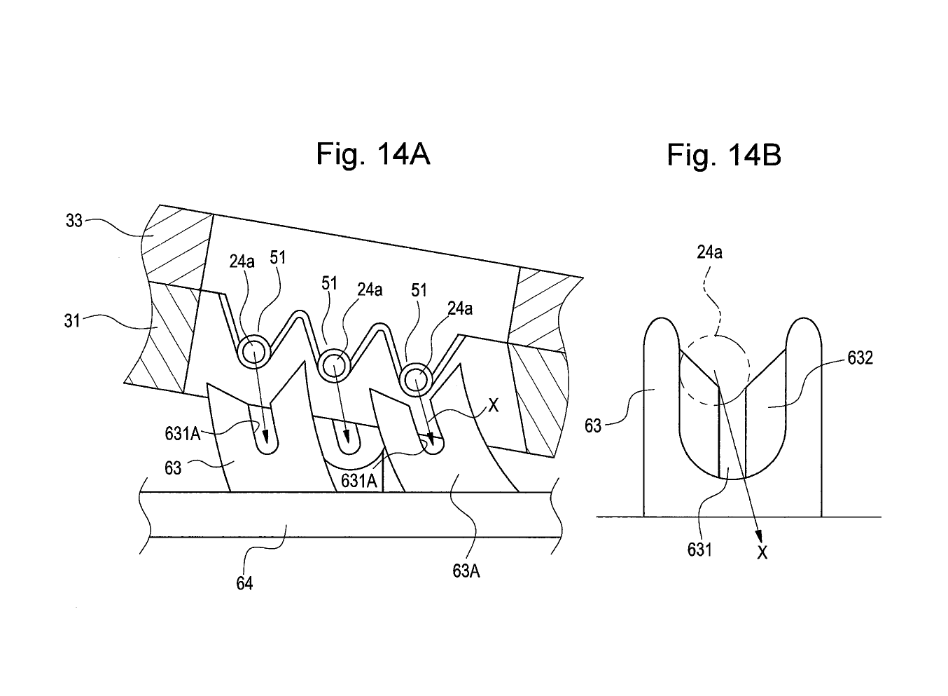

FIG. 13 is a view explanatory of improved press-contacting grooves of press-contacting terminals provided in a holder reception portion of the invention. FIG. 14A is an enlarged view showing the arc-shaped press-contacting grooves shown in FIG. 13, and FIG. 14B is a view explanatory of an operation in the first embodiment in which each press-contacting groove is straight.

In the holder reception portion J3 shown in FIGS. 13 and 14A, improvements are made on press-contacting terminals 63A arranged at a terminal fixing portion 64. As shown in the drawings, the press-contacting grooves 631A of the improved press-contacting terminals 63A into which wires 24a are to be inserted are formed into an arc-shape, and are disposed respectively on and along loci K1, K2 and K3 of movement of the wires 24a during a pivotal movement of a first wire holder H1 about a rotation center Ox defined by axes of mounting shaft portions 57. The loci K1, K2 and K3 of movement are defined by arcs having radiuses R1, R2 and R3 having their centers disposed on the rotation center Ox defined by the axes of the mounting shaft portions 57.

Therefore, as shown in FIG. 14A, the direction of extending of the press-contacting groove 631A of each press-contacting terminal 63A coincides with the direction (direction X in the drawings) of insertion of the corresponding wire 24a by the pivotal movement of the first wire holder H1.

In FIGS. 13 and 14, the first wire holder H1 to be attached to the holder reception portion J3 may be identical in construction to the first wire holder of the first embodiment. Except the improved press-contacting terminals 63A, the holder reception portion J3 shown in FIG. 13 may be identical in construction to the holder reception portion J1 of the first embodiment.

In the case of the press-contacting grooves 631 of the first embodiment shown in FIGS. 12A to 12E, each press-contacting groove 631 has a straight shape and extends straight in the vertical direction as shown in FIG. 14B. Therefore, the direction X of movement of the wire 24a by the pivotal movement of the first wire holder H1 does not coincide with the direction of extending of the press-contacting groove 631. As a result, the wire 24a is pressed into the press-contacting groove 631 while being offset to one side of this press-contacting groove, so that an offset load acts on the wire 24a, and this leads to a possibility that the wire cutting, etc., may occur because of the offset load.

However, according to the construction of the press-contacting terminals 63A shown in FIGS. 13 and 14, at the time when each wire 24a held at the first wire holder H1 is pressed into the press-contacting groove 631A of the press-contacting terminal 63A provided at the terminal fixing portion 64 by pivotally moving the first wire holder H1, the direction of extending of the press-contacting groove 631A coincides with the direction of insertion of the wire 24a since the press-contacting groove 631A is formed into the arc-shape and is disposed on and along the locus of movement of the wire 24a during the pivotal movement of the first wire holder H1. Therefore, there can be avoided a situation in which the wire 24a is pressed into the press-contacting groove 631A while being offset to one side of this press-contacting groove, so that an offset load acts on the wire 24a. Therefore, the wire cutting, etc., due to the offset load can be prevented, and the press-contacting connection of a high reliability can be achieved.

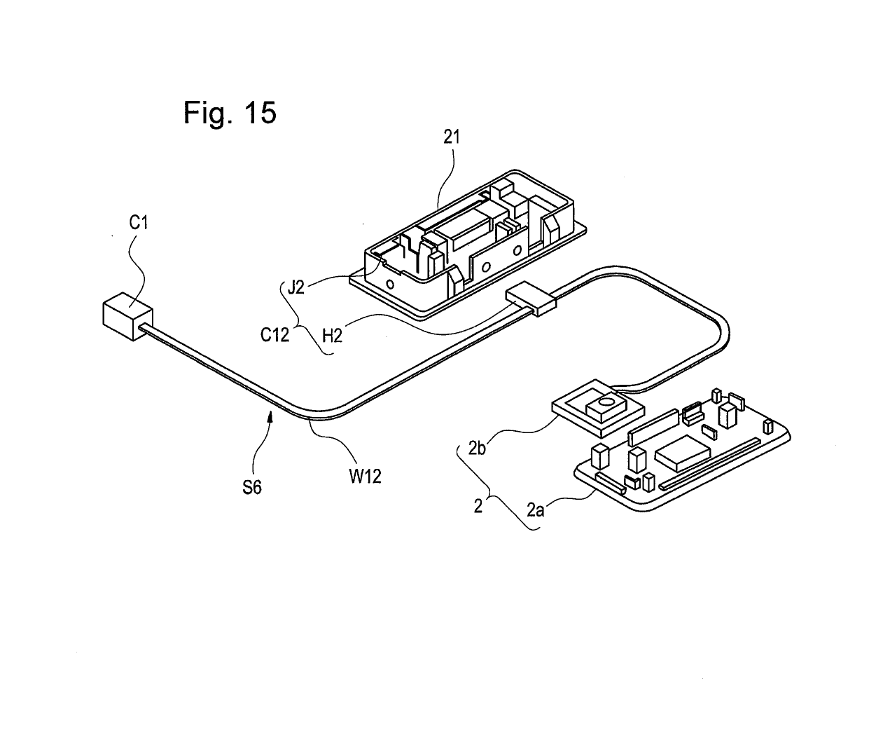

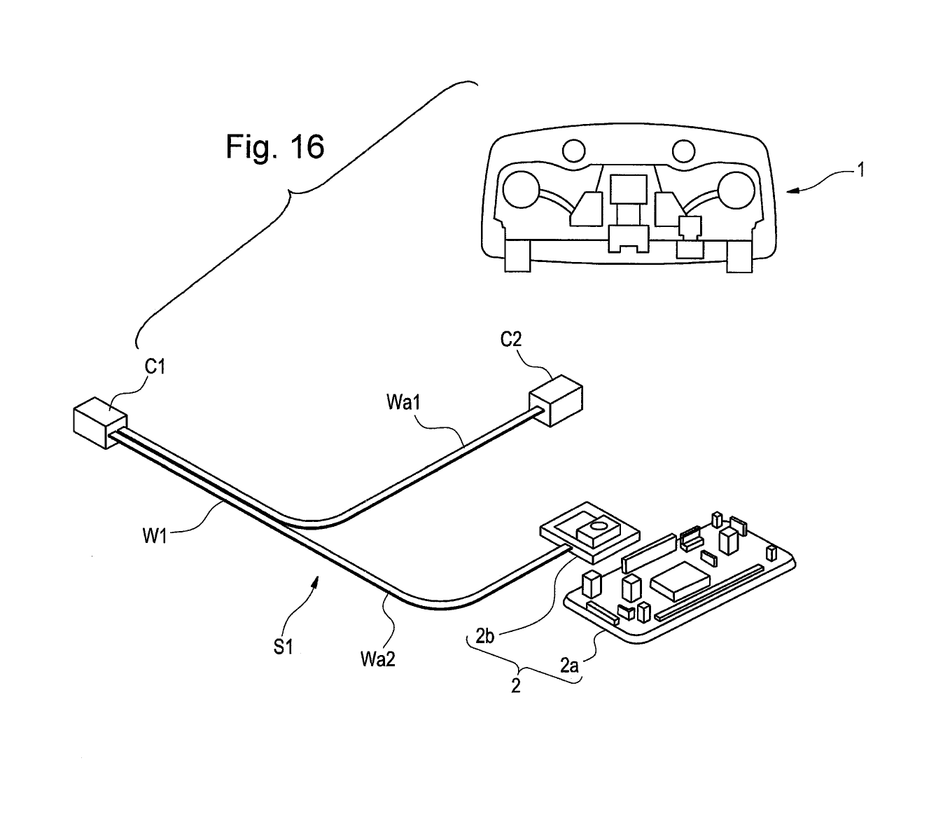

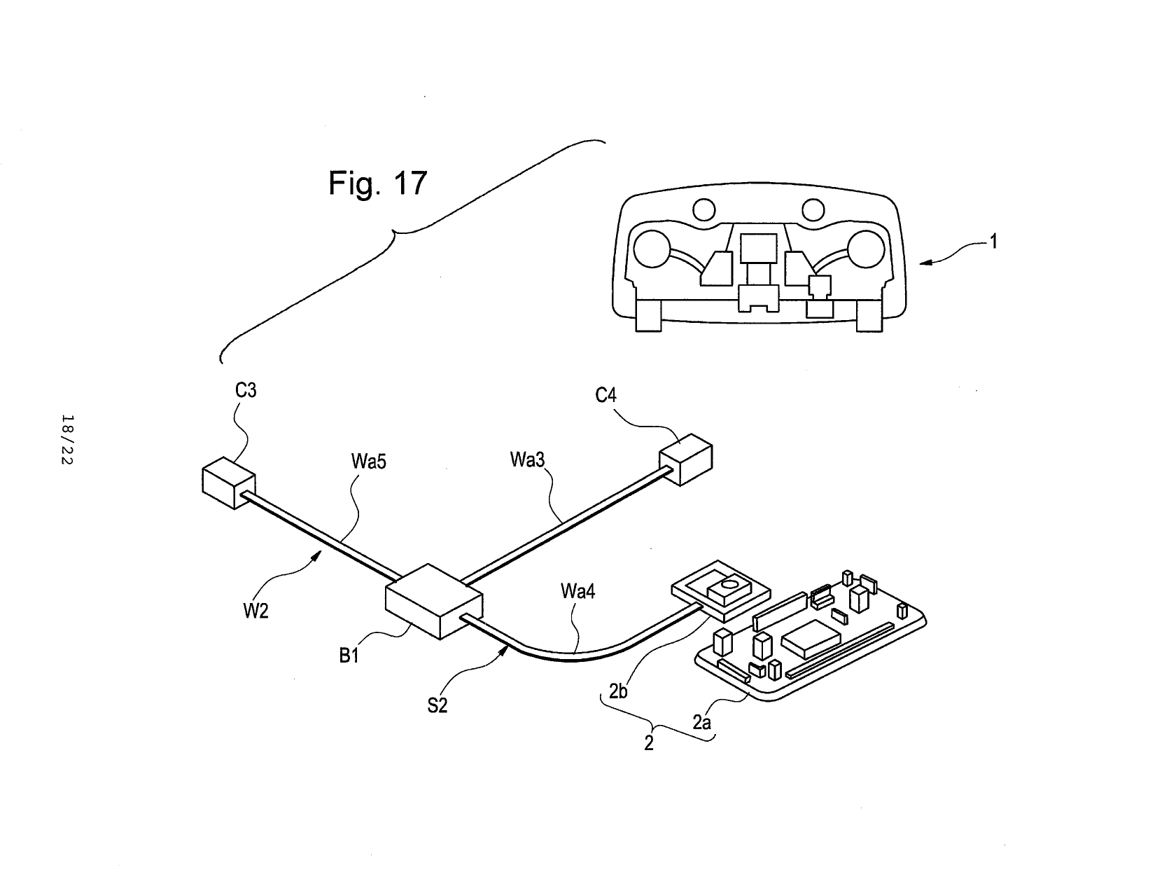

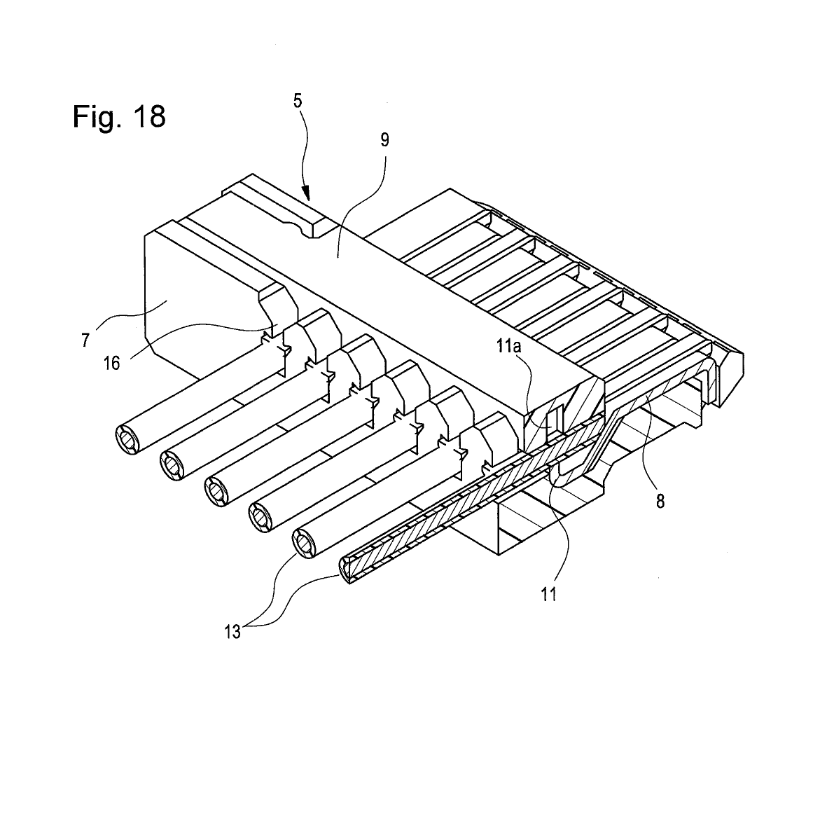

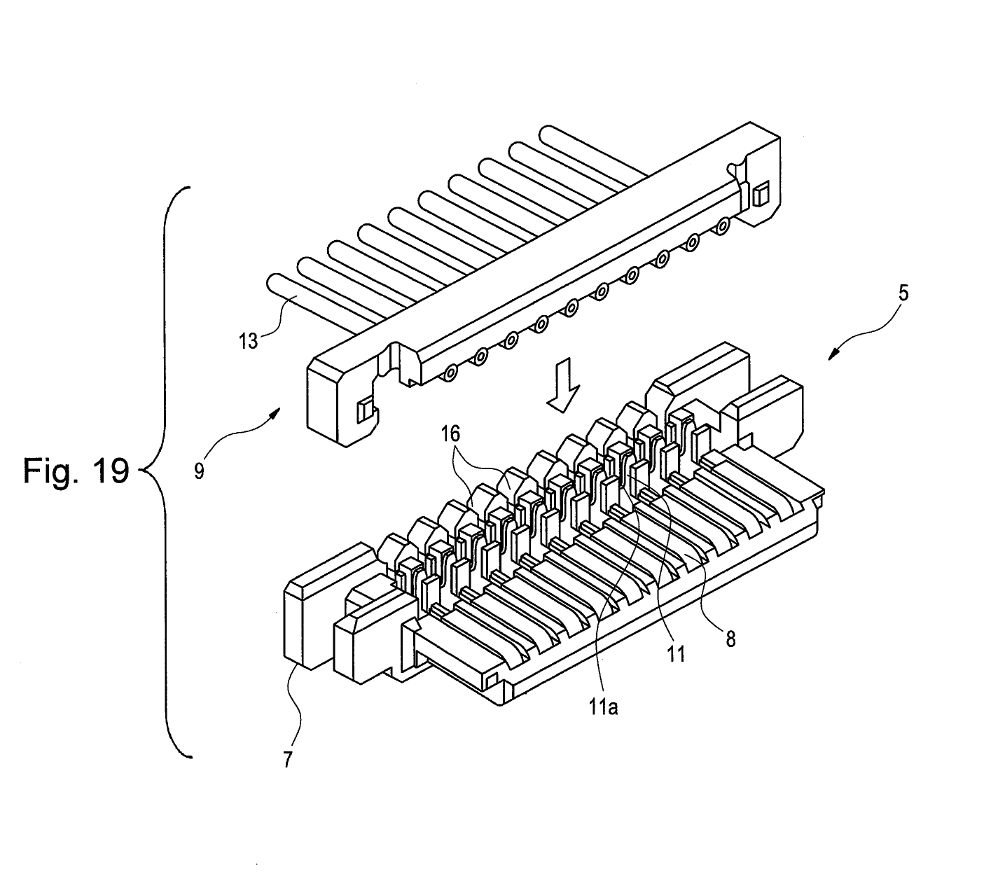

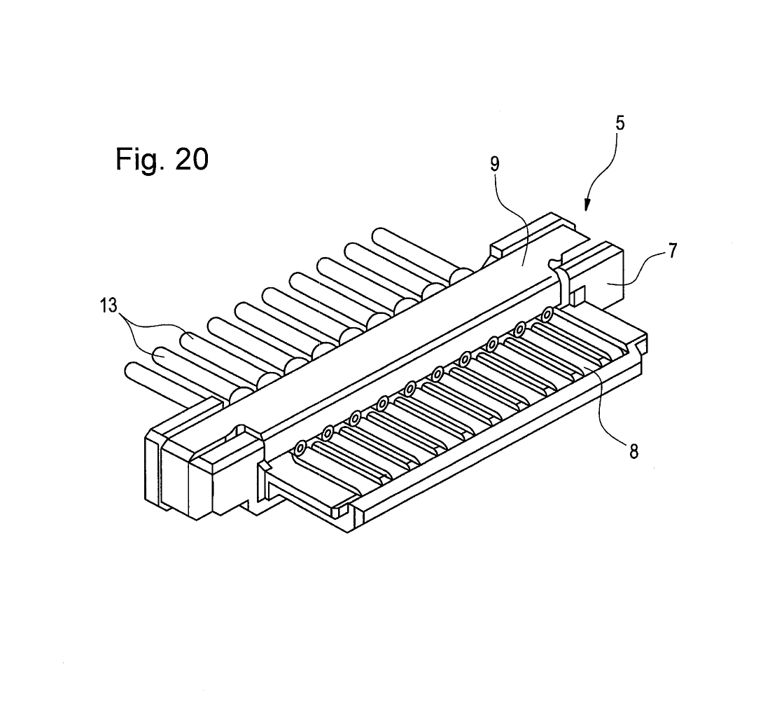

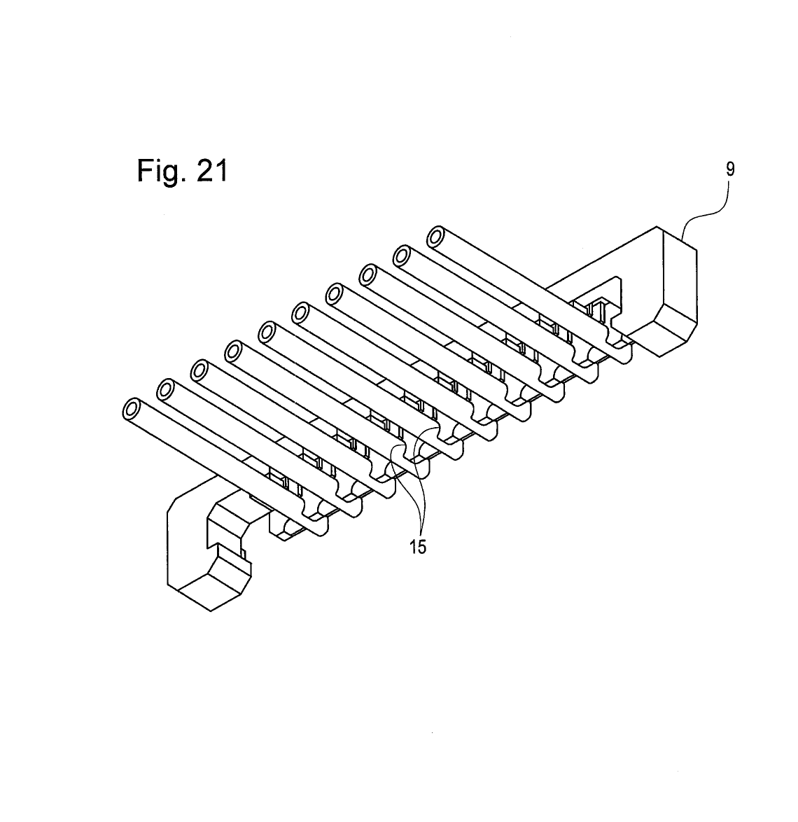

FIG. 15 is a view schematically showing the construction of a vehicular wire harness connecting structure according to a second embodiment of the present invention.

In the vehicular wire harness connecting structure S6 of this second embodiment, an electrical equipment 21 to be connected to an intermediate portion of a wire harness W12 is connected thereto by a connector C12 of the invention. However, with respect to an electrical equipment 2 to be connected to a distal end of the wire harness W12, the wire harness is connected directly to a function portion 2 of the electrical equipment 2.

In this embodiment, the electrical equipment 21 is an in-vehicle map lamp. The connector C12 for connecting the electrical equipment 21 to the wire harness W12 comprises a wire holder H2 which is mounted on the wire harness W12 and holds a plurality of wires (forming this wire harness W12) in parallel to each other, and a holder reception portion J2 provided as a harness connection portion at the electrical equipment 21. The basic construction of the wire holder H2 may be similar to that of the first wire holder H1 of the first embodiment except that the wire holder H2 holds the wires passing therethrough. Also, the basic construction of the holder reception portion J2 may be similar to that of the holder reception portion J1 of the first embodiment.

The electrical equipment 2 is a dome lamp for mounting on a ceiling portion above a driver's seat or other portion in a vehicle, and comprises a design portion 2a for being fixed to the ceiling portion, and the function portion 2b detachably attached to the design portion 2a.

As shown in FIG. 15, the wire harness connecting structure of the invention may be constructed such that part of the plurality of electrical equipments to be connected to the wire harness is connected thereto by the wire holder and the holder reception portion of the invention.

The connector and the vehicular wire harness connecting structure according to the present invention are not limited to the above embodiments, and suitable modifications, improvements, etc., can be made. Furthermore, the material, shape, dimensions, numerical values, form, number, disposition, etc., of each of the constituent elements of the above embodiments are arbitrary and are not limited in so far as the invention can be achieved.

This application is based upon and claims the benefit of priority of Japanese Patent Application No. 2009-268928 filed on Nov. 26, 2009, the contents of which are incorporated herein by reference.

### REFERENCE SIGNS LIST

2 electrical equipment (dome lamp)

2a design portion

2b function portion

21 electrical equipment (map lamp)

22 electrical equipment (dome lamp)

24 wire group

24a wire

31 inner frame body

33 outer frame body

35 thin hinge

41 wire holding groove

46 press-contacting blade passage hole

51 wire pressing portion

56 press-contacting blade passage hole

57 mounting shaft portion

58 mounting engagement portion

59 outer edge portion

61 holder shaft support portion

62 lock portion

63, 63A press-contacting terminal

64 terminal fixing portion

611 notched groove

612 withdrawal prevention portion

631, 631A press-contacting groove

C11, C12 connector

H1 first wire holder

H2 second wire holder

J1, J2 holder reception portion

Ox rotation center

S5, S6 wire harness connecting structure

W11, W12 wire harness

1. A connector comprising:
a wire holder adapted to be mounted on a wire harness and having a wire arranging portion that holds a plurality of wires configuring the wire harness in parallel relation to each other, and a holder reception portion provided at an electrical equipment and serving as a harness connection portion to which the wire harness is to be connected;
wherein the wire holder includes a mounting shaft portion disposed at one side of the wire arranging portion and spaced a distance from the one side of the wire arranging portion, and a mounting engagement portion disposed at the other side of the wire arranging portion and spaced a distance from the other side of the wire; and
the holder reception portion includes a holder shaft support portion that rotatably supports the mounting shaft portion, a lock portion that engages with the mounting engagement portion of the wire holder that pivotally moves using the holder shaft support portion as a rotation fulcrum so as to fix the wire holder, and a terminal fixing portion that has a plurality of press-contacting terminals that are arranged between the holder shaft support portion and the lock portion in accordance with an arrangement of the wires at the wire arranging portion so that when the wire holder is fixed to the lock portion, press-contacting connection of the press-contacting terminals to the wires disposed at the wire arranging portion is completed.

2. The connector according to claim 1, wherein the wire holder comprises an inner frame body that is located close to the terminal fixing portion when the wire holder is fixed to the holder reception portion, and an outer frame body that is superposed on an upper surface of the inner frame body to hold the plurality of wires between it and the inner frame body; and
the mounting shaft portion and the mounting engagement portion are formed integrally on the outer frame body.

3. The connector according to claim 1, wherein the outer frame body of the wire holder has an outer edge portion extending to be disposed outwardly of the mounting shaft portion relative to the wire arranging portion; and
the holder shaft support portion includes a notched groove into which an end portion of the mounting shaft portion is inserted in a direction perpendicular to an axis of the mounting shaft portion when the wire holder is disposed in a vertically-upstanding condition relative to the holder reception portion, and a withdrawal prevention portion constructed such that when the wire holder is pivotally moved toward the terminal fixing portion after the mounting shaft portion reaches an inner end of the notched groove, the withdrawal prevention portion abuts against the outer edge portion moving outside the notched groove by this pivotal movement, thereby restraining withdrawal of the mounting shaft portion.

4. The connector according to claim 1, wherein the press-contacting terminals arranged at the terminal fixing portion have respective press-contacting grooves into which the wires are inserted, respectively, and the press-contacting grooves are formed into an arc-shape, and are disposed receptively on and along loci of movement of the wires during the pivotal movement of the wire holder.

5. A vehicular wire harness connecting structure in which the wire holder as defined in claim 1 is mounted on a connection portion of a wire harness to be connected to an in-vehicle electrical equipment, and the holder reception portion as defined in claim 1 is provided at the electrical equipment, and the wire holder is fixed to the holder reception portion of the electrical equipment so as to connect the electrical equipment and the wire harness.
